(19) United States
(12) Patent Application Publication
(10) Pub. No.: US 2004/0154038 A1
(43) Pub. Date: Aug. 5, 2004

(54) Disk cartridge

(76) Inventors: Akira Kurozuka, Osaka (JP); Eiichi Hanakawa, Kyoto (JP); Tomio Yamamoto, Hyogo (JP)

Correspondence Address: RatnerPrestia, One Westlakes Berwyn Suite 301, PO Box 980, Valley Forge, PA, 19482-0980, US

(21) Appl. No.: 10/473,194

(22) PCT Filed: Oct. 18, 2002
(86) PCT No.: PCT/JP02/10813

(30) Foreign Application Priority Data
Oct. 23, 2001 (JP) 2001-324708

(51) Int. Cl. G11B 23/03

(52) U.S. Cl. 720/739; 360/133

(57) ABSTRACT

A magneto-optical disk drive has a problem that it is difficult to render it low-profile because there is a magnetic head elevating mechanism in an upper part of a cartridge.

A notch 1e and concave portions 1c, 1d are formed on openings 1a, 1b for having a magnetic head 10 of a disk cartridge 1 inserted.

A diskcartridge has a slide plate 14 slidably mounted on a top surface of a cartridge holder 9, a lift member 16 rotatably supported on the slide plate 14 and a driver 17 for moving the slide plate 14 in parallel by a predetermined amount, and lifts up the magnetic head 10 by moving the lift member 16 which goes into the openings 1a, 1b of the disk cartridge 1.

### TECHNICAL FIELD

The present invention relates to a disk cartridge for recording and reproducing information on a disk-like record medium, and in particular, to a disk cartridge for a magneto-optical disk.

### BACKGROUND ART

In the past, there were proposals of recording and/or reproducing apparatuses constituted to record and/or reproduce an information signal by using a record medium such as a magneto-optical disk or an optical disk. As for the record medium, a disk cartridge constituted by accommodating the magneto-optical disk or optical disk in a cartridge case is proposed. And the recording and/or reproducing apparatus are constituted by having an optical pickup and a magnetic head for writing and/or reading the information signal to and/or from the record medium.

They are diffused as optical disk drives used for an audio disk, a video disk or a data storage unit of a computer. Of such apparatuses, an MD (minidisk) apparatus using a minor-diameter disk and miniaturized as an audio disk drive is diffused as an apparatus suited for portable use. Not only audio/video (AV) equipment such as the MD but also personal computers are rapidly miniaturized and rendered portable so that optical disk drives are expected to be further miniaturized and rendered low-profile.

In order to obtain a capacity necessary to sufficiently record an image or a moving picture on a small disk, an improvement in recording density is essential. In recent years, the technology for improving the recording density of the optical disk made rapid progress, and unprecedented high recording density is realized as to the magneto-optical disk in particular since various super-resolution readout systems have been developed.

As for a magneto-optical disk drive, the magnetic head for recording is held at an end of a blade-spring-like supporting member and faces a recording area of the disk from an opening provided to the disk cartridge so as to be coupled to the optical pickup and transported in a radial direction of the disk in one with the optical pickup. The magnetic head is pressed on a disk surface by the supporting member so that it comes close to or slides on the disk surface on recording, and applies from a backside of the disk a predetermined magnetic field to a position of a laser spot irradiated from the optical pickup.

On reproduction, the information is only read by the optical pickup, and so the magnetic head is not necessary. Normally, a magnetic head elevating mechanism is provided in order to prevent the disk surface and magnetic head from being worn away and damaged. The mechanism makes the magnetic head come close to or slide on the disk only on recording and makes it clear of the disk surface and recede on reproduction.

Hereafter, a description will be given by referring to the drawings as to the disk cartridge and drive unit of such a magneto-optical disk in the past. FIG. 11 is a cartridge used for a disk drive in the past. FIG. 12 is a plan view showing a configuration of the disk drive in the past, and FIG. 13 is a cross-sectional view thereof (refer to Japanese Patent Laid-Open No. 8-36800 for instance).

In FIG. 11, a disk cartridge 31 accommodates a disk 32 to be freely rotatable inside and also has an opening 33 faced by the optical pickup, spindle motor and magnetic head. When the disk cartridge 31 is inserted into the drive unit, a shutter 34 moves in parallel with an inserting direction (arrow) to expose the opening 33, and blocks it when taken out of the drive unit inversely. The shutter 34 is a plate-like member having an approximately horseshoe cross-section to cover the opening 33 on both principal surfaces of the disk cartridge 31. An engraved portion 311 is formed in the area around the opening 33 in which the shutter 34 moves so that the shutter 34 will not exceed the thickness of the disk cartridge 31.

In FIGS. 12 and 13, the disk cartridge 31 accommodating such a disk 32 is stored in a holder 39 to be capable of recording and reproduction.

The holder 39 is mounted to be able to rotate and rise by means of a rotary axis 351 provided at both ends of the depths of a chassis 35.

The chassis 35 has a guide shaft 38 provided thereto, and an optical pickup 37 is transported by a transport motor (not shown) in a radial direction of the disk 32 along the guide shaft 38. A spindle (not shown) is provided at the center of the chassis 35, and the spindle and the optical pickup 37 face the disk 32 from the opening 33 in the lower part of the disk cartridge 31.

The holder 39 has a window portion 391 formed on its top surface, which almost overlaps the opening 33 in the upper part of the inserted disk cartridge 31.

A magnetic head 40 is mounted at the end of a suspension 41 and is coupled to the optical pickup 37 by an angle 43 so that they are transported in one in the radial direction of the disk 32. The angle 43 has a magnetic head base 42 provided thereto at the same time, which is held in parallel with the disk 32 in the upper part of the angle 43 and pressed in the direction of the disk 32 by a blade spring 57.

In this condition, the suspension 41 bends more upward than natural condition, and the magnetic head 40 goes through the opening 33 of the disk cartridge 31 from the window portion 391 on the top surface of the holder 39 so as to contact the disk 32 and be pressed. It causes the magnetic head 40 to slide against the disk with a predetermined pressure and give the magnetic field to a position of a beam spot irradiated from the optical pickup 37 so that it is in a recordable state.

Change of a vertical position and an angle of the magnetic head due to a side-runout of the disk 32 and so on is absorbed as a gimbal suspension portion 53 at the end of the suspension 41 deforms. As the pressure for pressing the magnetic head 40 against the disk 32 is set as a slight force in order to prevent the disk 32 from bending greatly, the gimbal suspension portion 53 has a flexible configuration of very low rigidity.

In order to insert the magnetic head 40 from the opening of the disk cartridge 31 so that it contacts the disk 32, the suspension 41 is in a bending shape accompanied by a step from a mounting surface of the angle 43 to the disk surface.

The holder 39 has a slide plate 44 mounted on its top surface to be slidable in a cartridge inserting direction, and an engagement portion 451 of the slide plate 44 reaches an under surface of the holder 39 from a side surface of the holder 39 and is driven by a driving mechanism (not shown) installed in the lower part of the holder 39.

Furthermore, a lift plate 46 is axially supported on the top surface of the holder 39, and when the slide plate 44 is driven to a depth side (right side in the drawing) of the holder, a projection 47 of the lift plate 46 is lifted by a projection 45 which is inclined and formed at the end of the slide plate 44 so that the lift plate 46 becomes inclined with its end upheaved.

The lift plate 46 has its central portion 462 dented further than both end portions 461. The magnetic head suspension 41 located in the upper portion of the lift plate 46 is upheaved as the lift plate 46 rotates, no matter where it is positioned between an inner radius and a circumference of the disk 32, so that a magnetic head 10 is put in a state of being dissociated from the disk 32 (hereafter, referred to as a lift-up state). Normally, the magnetic head is in contact with the disk only on recording, and it is lifted up on reproduction so as to prevent the disk and magnetic head from being worn away and damaged.

FIG. 14 is a plan view of the state of having the magnetic head lifted up, and FIG. 15 is a cross-sectional view of the state of having the magnetic head lifted up. In FIGS. 14 and 15, the slide plate 44 is moved to the depth side of the holder by the driving mechanism installed in the lower part of the holder 39. The inclined projection 45 gets under the projection 47 of the lift plate 46 so that the lift plate 46 is upheaved around the axis and thereby inclined and has the magnetic head suspension 41 deformed on the topside and upheaved. In this case, the end portion of the magnetic head suspension 41 is in contact with the under surface of the magnetic head base 42 and the gimbal suspension portion 53 is inversely deformed downward so that the magnetic head 40 and the magnetic head suspension 41 are accommodated between the top surface of the disk cartridge 31 and the magnetic head base 42.

The purposes of putting the end portion of the magnetic head in contact with the magnetic head base 42 are to prevent the end portion of the magnetic head from projecting further than the height of the magnetic head base and increasing the thickness of the entire apparatus and to prevent the magnetic head suspension 41 from deforming due to an external force such as a drop impact when lifted up.

However, there are the following problems as to the disk cartridges and disk drives of the past configuration.

As shown in FIGS. 13 and 15, the thickness of the apparatus shown by a dimension D is determined by a total of the thickness of the chassis 35, thickness of the disk cartridge 31 and thickness of the magnetic head elevating mechanism in the upper part of the disk cartridge 31. As for a lift amount L of the lift plate 46, the lift amount of at least a step H between the cartridge top surface and disk surface is required to upheave the magnetic head 40 until it contacts the magnetic head base 42 in the upper part of the cartridge.

Incidentally, it is thinkable to render the step H smaller, that is, to render the lift amount L smaller in order to render the dimension D smaller. If the lift amount L is rendered smaller than required, however, there is a possibility that, in a state of having the magnetic head 40 descending on the surface of the disk 32, a clearance S between the central portion 462 of the lift plate 46 and the magnetic head suspension 41 cannot be sufficiently taken and so the central portion 462 of the lift plate 46 may contact the magnetic head suspension 41 during the recording. Therefore, it is necessary to take the lift amount L which is sufficiently large so that the dimension D becomes large and the entire apparatus cannot be rendered low-profile.

If the driving mechanism for elevating the magnetic head is provided in the upper part of the holder, the thickness of the apparatus significantly increases. And even if it is provided in the lower part of the cartridge as in the aforementioned past example, the thickness of the apparatus is restricted by the thickness of the driving mechanism so that, no matter how low-profile the spindle and optical pickup are rendered, it becomes difficult to render the entire apparatus low-profile. Moreover, it is necessary to convey power from the lower part of the cartridge to the lift plate located in the upper part so that the configuration becomes complicated.

### DISCLOSURE OF THE INVENTION

The present invention solves the above problems, and an object thereof is to render a disk drive small and low-profile by securely elevating the magnetic head with a simple configuration.

A first invention of the present invention is a disk cartridge having a cartridge case for rotatably accommodating a disk for recording an information signal and a shutter, wherein:

a first opening for having a magnetic head for recording and/or reproduction on said disk inserted is provided on a first principal surface of said cartridge case;

a second opening for having a spindle for rotating and driving said disk inserted is provided on a second principal surface of said cartridge case;

said shutter closes or opens said first and second openings;

in an area around said first and second openings corresponding to a sliding range of said shutter, an engraved portion is formed so that said shutter will not project from the thickness of said cartridge case; and

on a part of said engraved portion on one side on an inner radius side of the disk of said first opening, an inner radius side concave portion is formed in the direction in which said first opening widens.

A second invention of the present invention is the disk cartridge according to the first invention of the present invention, wherein said inner radius side concave portion is formed by notching a part of said engraved portion.

A third invention of the present invention is the disk cartridge according to the first or the second invention of the present invention, wherein a circumferential side concave portion is formed, in the direction in which said first opening widens, at least in said engraved portion at a position corresponding to said inner radius side concave portion on one side on the circumferential side of the disk of said first opening.

A fourth invention of the present invention is the disk cartridge according to the third invention of the present invention, wherein said circumferential side concave portion is formed by chamfering said engraved portion.

A fifth invention of the present invention is the disk cartridge according to the first invention of the present invention, wherein a clamp plate to be absorbed by said spindle is provided at the center of said disk, a concave portion is formed at a position corresponding to said clamp plate on an inner surface of said cartridge case, and the inner radius side concave portion of said first opening is provided in a range not overlapping said concave portion.

According to the present invention of such a configuration, it is possible to have the following effects, for instance.

It is possible to drop a lift member into the opening without narrowing the width of a magnetic head suspension.

It is possible to widen a part of the opening without increasing the thickness of the cartridge.

It is possible to render the drive low-profile without requiring large thickness in the upper part of the cartridge.

It is possible to constitute a lift member simply and inexpensively and move a position of the lift member securely with a simple configuration.

It is possible to drop the lift member into the opening without narrowing the width of the magnetic head suspension.

Even if the magnetic head does not recede completely to the upper part of the cartridge when lifted up, it does not contact the cartridge when replacing the cartridge, and so the cartridge can be smoothly replaced. Therefore, the space required for the upper part of the cartridge can be held down to a minimum, and the apparatus can be rendered low-profile.

### BRIEF DESCRIPTION OF THE DRAWINGS

FIG. 1 is a perspective view showing a first principal surface side according to an embodiment of a disk cartridge of the present invention;

FIG. 2 is a perspective view showing a second principal surface side according to the embodiment of the disk cartridge of the present invention;

FIG. 3 is a sectional view of the disk cartridge according to the present invention;

FIG. 4 is a perspective view showing a configuration of a disk drive related to the present invention;

FIG. 5 is an exploded perspective view of a magnetic head elevating mechanism related to the present invention;

FIG. 6 is a plan view of the disk drive related to the present invention in a state in which a magnetic head has descended;

FIG. 7 is a cross-sectional view of the drive unit related to the present invention in the state in which the magnetic head has descended;

FIG. 8 is a plan view of the disk drive related to the present invention in a state of having the magnetic head lifted up;

FIG. 9 is a cross-sectional view of the disk drive related to the present invention in the state of having the magnetic head lifted up;

FIG. 10 is a cross-sectional view of the disk drive related to the present invention in the state of having a holder rotatively upheaved;

FIG. 11 is a perspective view showing a disk cartridge in the past;

FIG. 12 is a plan view showing a configuration of the drive unit in the past;

FIG. 13 is a cross-sectional view showing the configuration of the drive unit in the past;

FIG. 14 is a plan view showing the drive unit in the past in the state of having the magnetic head lifted up; and

FIG. 15 is a cross-sectional view showing the drive unit in the past in the state of having the magnetic head lifted up.

### DESCRIPTION OF SYMBOLS)

1 Disk cartridge

1a, 1b Openings

1c, 1d Engraved portions

1e Notch

1f Chamfer

2 Disk

3 Cartridge end

4 Shutter

5 Chassis

6 Spindle motor

7 Optical pickup

8 Guide shaft

9 Holder

9a Overhang

10 Magnetic head

11 Suspension

12 Magnetic head base

13 Angle

14 Slide plate

15 Bearings

16 Lift member

17 Driving means

18 Elevating motor

19 Reduction mechanism

20 Driving arm

21 Engagement hook

22 Presser bar spring

23 Gimbal suspension portion

24 Holder link

25 Projection

### BEST MODE FOR CARRYING OUT THE INVENTION

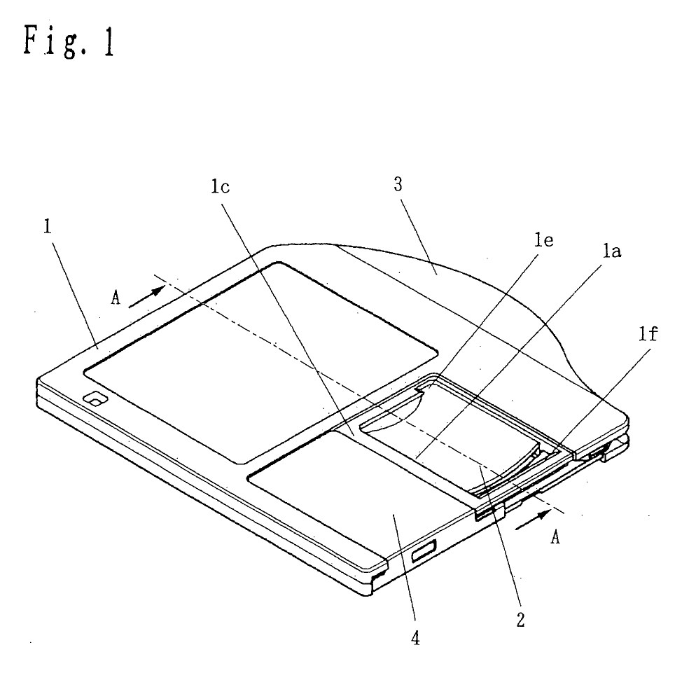

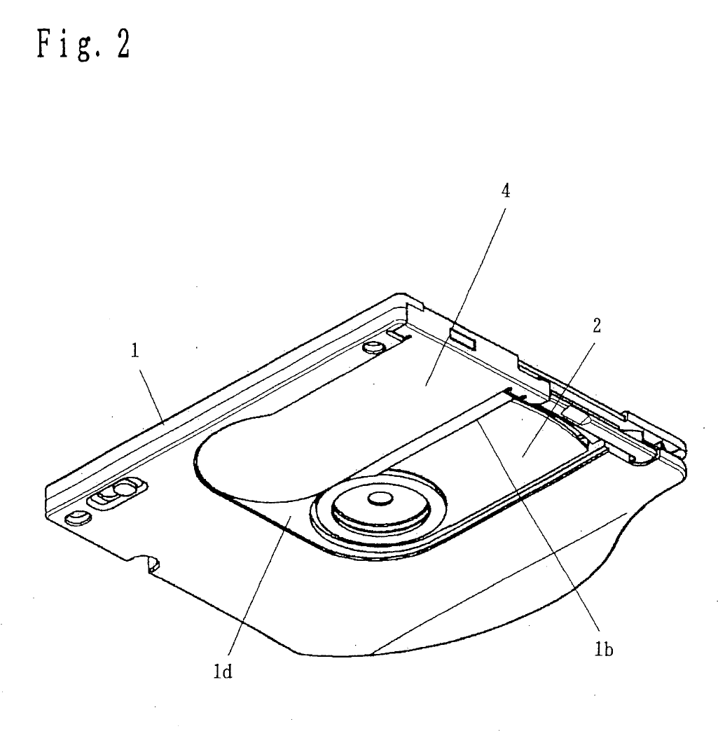

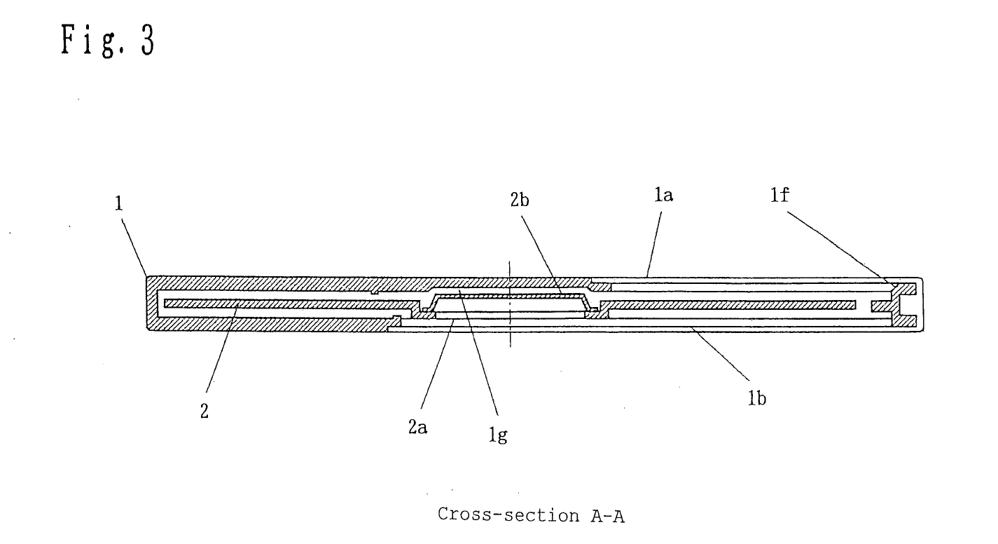

Hereafter, an embodiment of the present invention will be described by using the drawings. FIGS. 1 and 2 are perspective views showing the embodiment of a disk cartridge according to the present invention, where FIG. 1 shows a first principal surface side and FIG. 2 shows a second principal surface side. FIG. 3 is a sectional view of the disk cartridge according to the present invention.

In FIGS. 1 and 2, an inserting end 3 of a disk cartridge 1 to a drive unit is comprised of a curve incorporating a disk 2, and the rest is in an approximately square shape.

The disk cartridge 1 accommodates the disk 2 to be freely rotatable inside and also has an opening 1a for having a magnetic head inserted on the first principal surface and an opening 1b for having an optical pickup and a spindle motor inserted on the second principal surface. When the disk cartridge 1 is inserted into the drive unit, a shutter 4 moves in parallel with an inserting direction to expose the openings, and blocks them in a state of being taken out of the drive unit.

The shutter 4 is a plate-like member having an approximately horseshoe cross-section to cover the openings 1a, 1b on both principal surfaces of the disk cartridge 1. Engraved portions 1c, 1d are formed in the area around the openings 1a, 1b in which the shutter 4 moves so that the shutter 4 will not exceed the thickness of the disk cartridge 1.

A notch 1e is formed, by notching a part of the engraved portions 1c, on one side on an inner radius side of the disk 2 of the opening 1a on the first principal surface. The notch 1e is an example of a concave portion on the inner radius side of the present invention. In addition, a chamfer 1f is formed in the direction in which the opening widens on one side on a circumferential side of the disk 2 of the opening 1a. The chamfer 1f is an example of the concave portion on the circumferential side of the present invention.

The notch 1e is completely covered by the shutter 4 so that there will be no clearance in the openings when the shutter 4 is closed. It does not impair the appearance of the disk cartridge 1. It is possible, by shaping the opening 1a like this, to render the length of the opening 1a in a radial direction of the disk partially wider.

In FIG. 3, the center of the disk 2 has a periphery of a center hole 2a projecting downward and a clamp plate 2b of a magnetic substance mounted thereon so as to be in a partially thick shape. In order for the disk 2 to be rotated without contact in the disk cartridge 1, an appropriate air space is necessary in the disk cartridge 1. Therefore, a concave portion 1g is provided on an inner surface of the disk cartridge 1 to secure the air space at the center and render the disk cartridge 1 thin.

On the other hand, it is desirable, as mentioned later, that the opening 1a be as wide as possible in order to insert the magnetic head. However, if the shutter 4 is rendered longer toward the inner radius side of the disk for that purpose, the engraved portions 1c overlaps the concave portion 1g on the inner surface. If the wall thickness of this portion is rendered thicker then, the disk cartridge 1 becomes thicker. Nevertheless, the aforementioned notch 1e does not cause such a problem since it is just one portion and does not overlap the concave portion 1g so that the opening 1a can be rendered wider just in part.

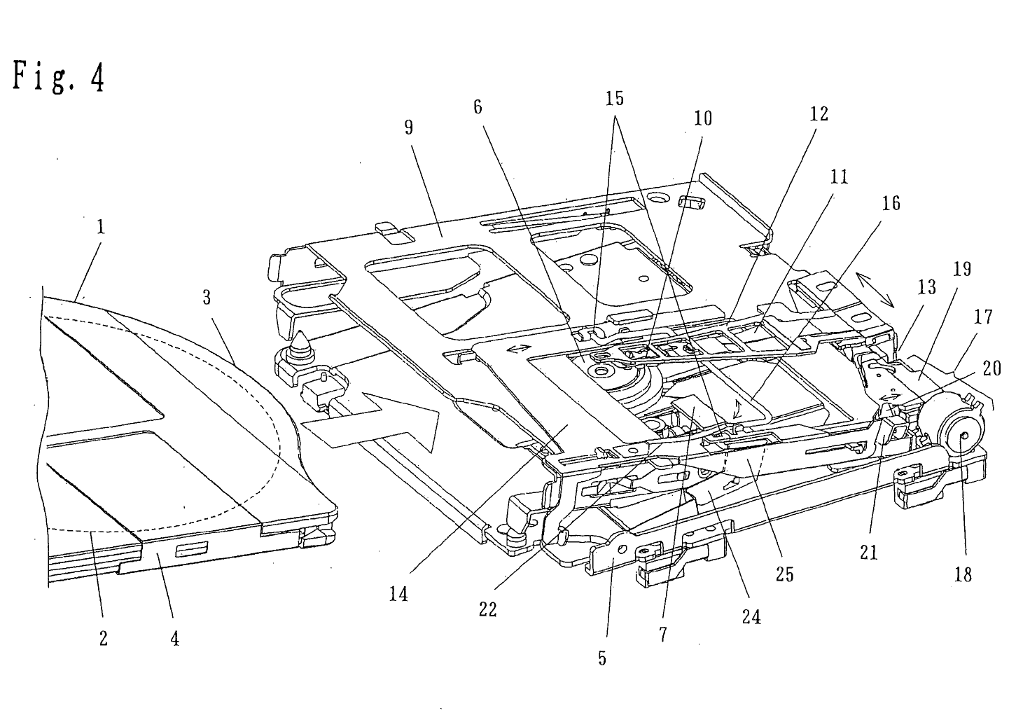

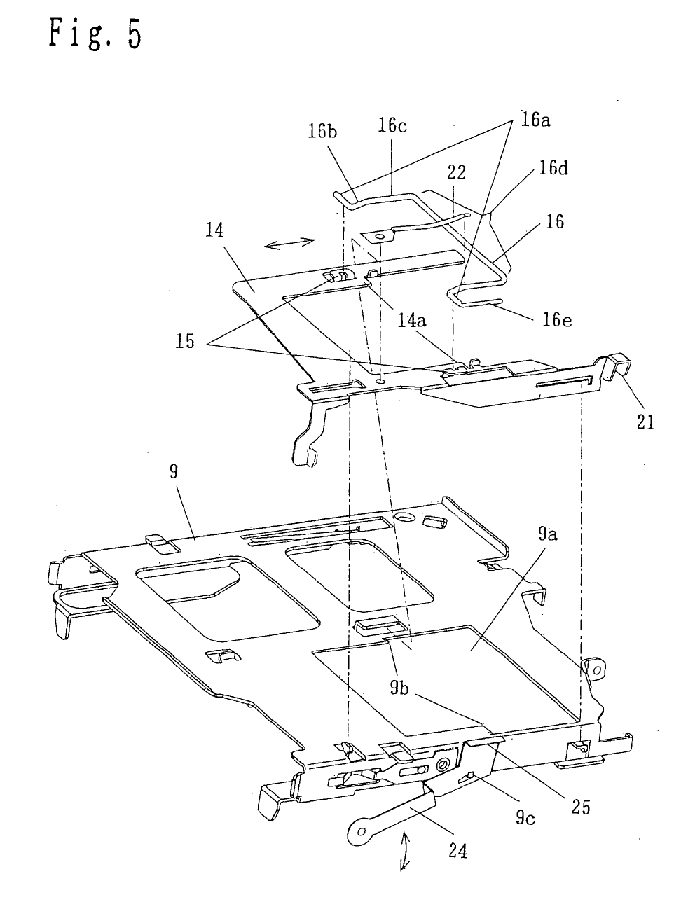

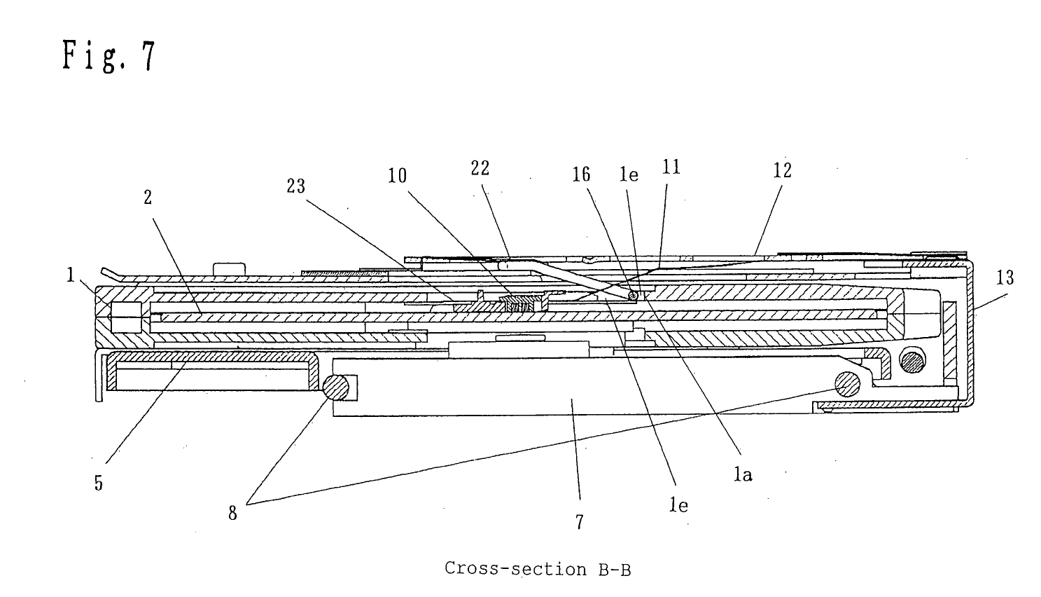

Next, the embodiment of a disk drive according to the present invention will be described. FIG. 4 is a perspective view showing a configuration of the disk drive according to the present invention, and FIG. 5 is an exploded perspective view of a magnetic head elevating mechanism. In FIGS. 4 and 5, a chassis 5 has a spindle motor 6 fixed at its center, which rotates and drives the disk 2 contained in the disk cartridge 1. As an optical pickup 7 writes and/or reads an information signal recorded on the disk 2, it is held to be movable on the inner radius and circumference of the disk 2 along a guide shaft 8 (refer to FIG. 7) fixed on the chassis 5.

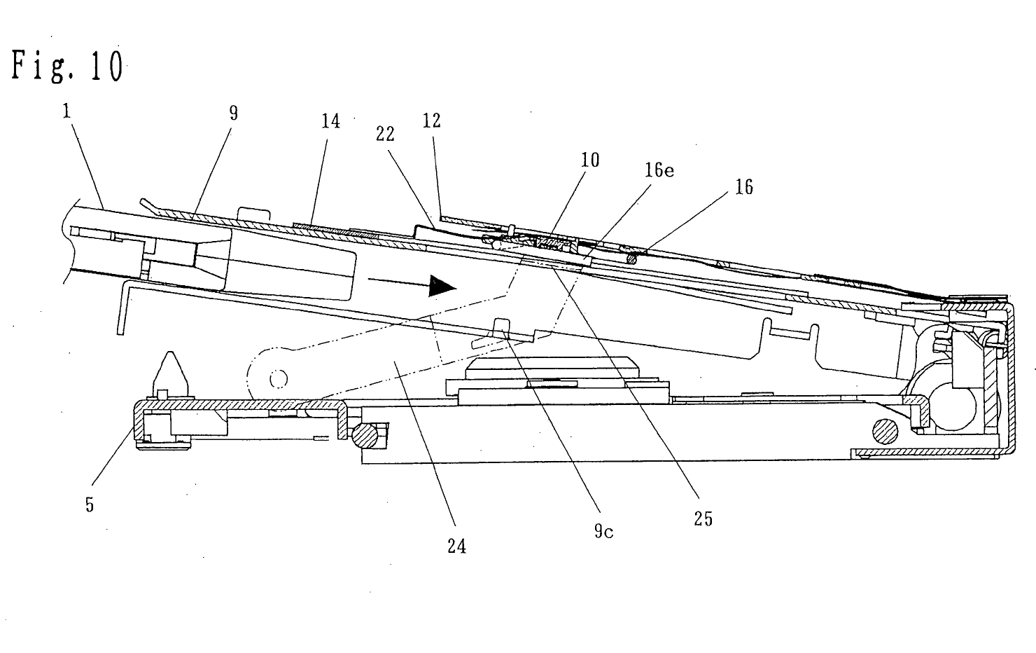

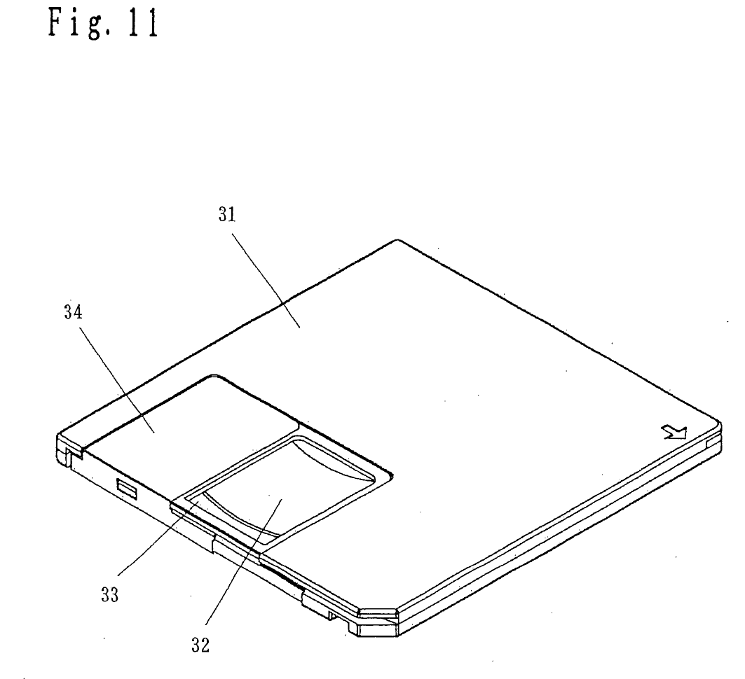

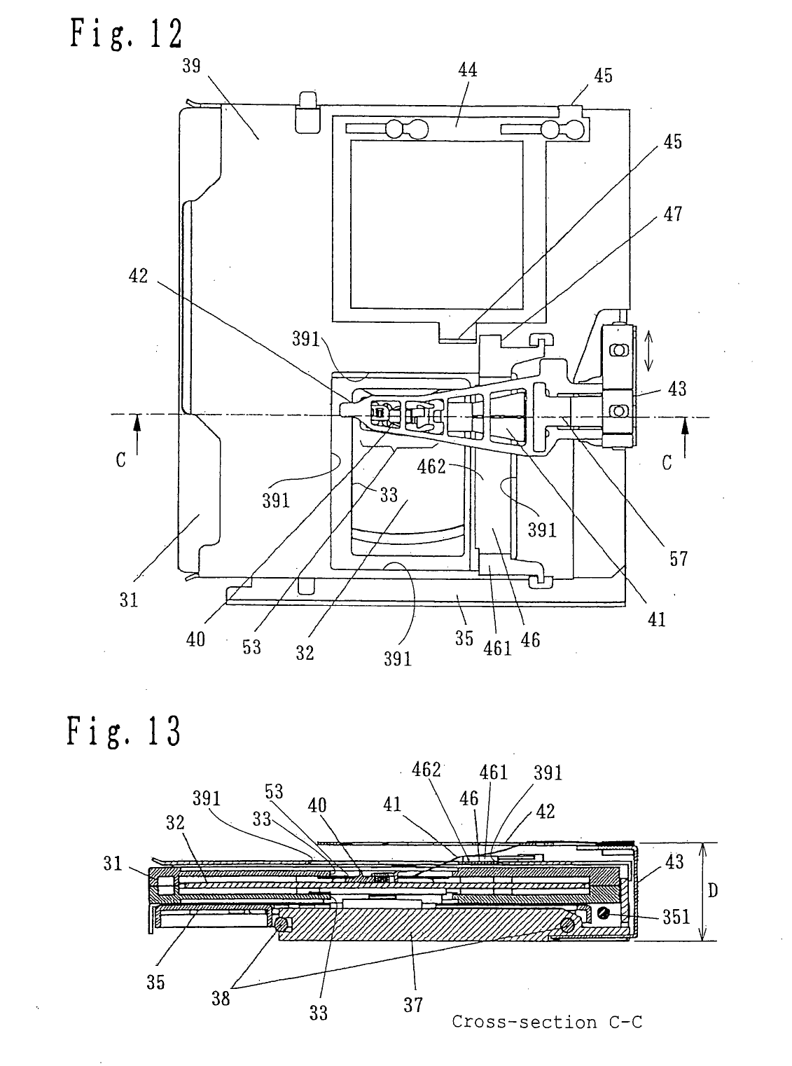

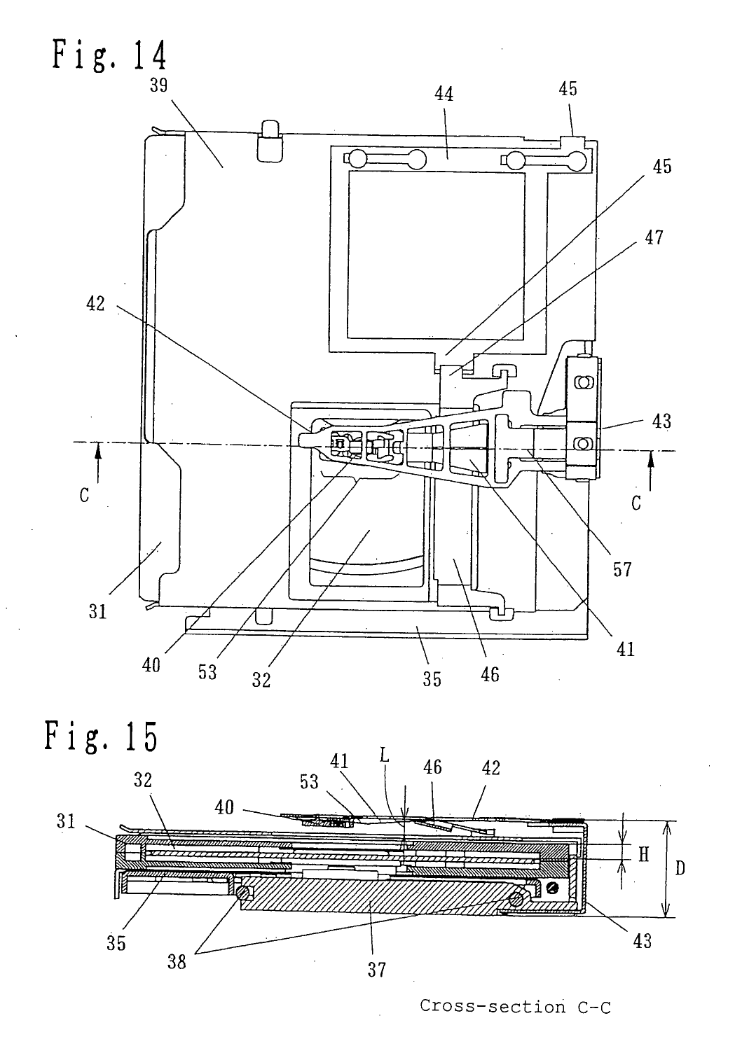

In the upper part of the chassis 5, a holder 9 is rotatably mounted around rotary axes provided at both ends of the depths thereof. If the holder 9 rotates and lowers after amounting the disk cartridge 1, the disk 2 becomes capable of recording and reproduction (refer to FIG. 10).

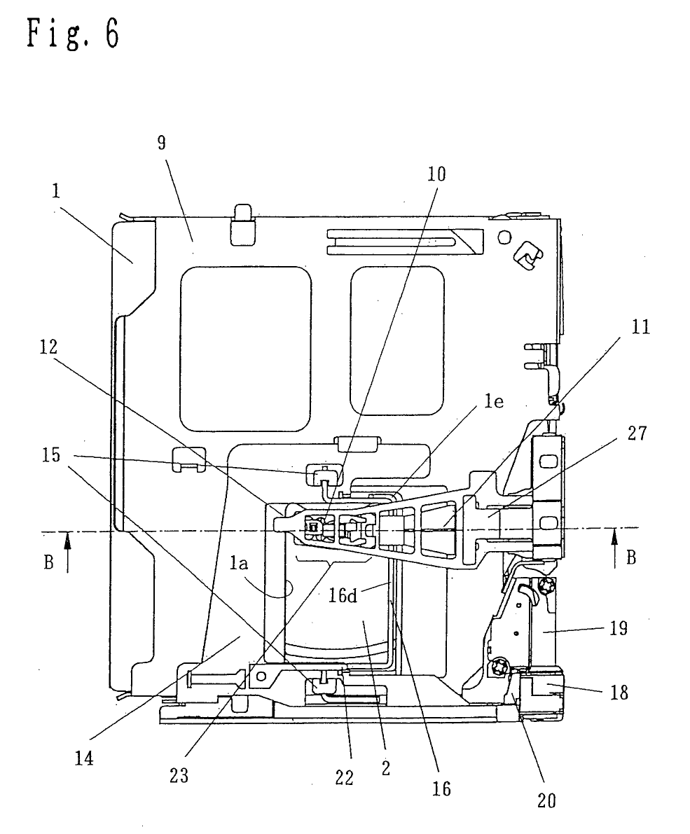

As in the past example, a magnetic head 10 is provided at the end of a suspension 11, and is coupled to the optical pickup 7 together with a magnetic head base 12 by an angle 13. The magnetic head base 12 is energized on the disk 2 side by a blade spring 27 (refer to FIG. 6), supported in parallel with the disk 2, and mounted at a position lower than the past example. The reason will be described later.

On the top surface of the holder 9, a slide plate 14 is slidably mounted in parallel with the inserting direction of the disk cartridge 1, and a lift member 16 in a bent shape is rotatably mounted on a pair of bearings 15 provided on the slide plate 14. The slide plate 14 is driven by a driving means 17 placed at a corner of the drive unit. The driving means 17 is comprised of an elevating motor 18, a reduction mechanism 19 and a driving arm 20. Rotation of the elevating motor 18 is decelerated by a column of gears of the reduction mechanism 19. A cam is provided in the last step of the column, and is engaged with a cam groove of the driving arm 20.

With such a configuration, the driving arm 20 is caused to reciprocatively rotate by the rotation of the elevating motor in one direction. The end of the driving arm 20 is engaged with an engagement hook 21 of the slide plate 14. Thus, the rotation of the elevating motor 18 causes the slide plate 14 to slide back and forth together with the lift member 16.

When the optical pickup 7 is sent to the most circumferential side of the disk 2 together with the magnetic head 10, the angle 13 reaches a side of the elevating motor 18, and the reduction mechanism 19 gets under the angle 13.

The lift member 16 is formed by inflecting a wire-like member, and is comprised of an axial portion 16a, an even portion 16b, an inclined portion 16c inclined downward, a contact portion 16d and an arm portion 16e. The axial portion 16a is supported by the pair of bearings 15 provided on the slide plate. If there is no obstacle, the even portion 16b is energized to contact a shelf portion 14a of the slide plate 14 by a presser bar spring 22, the inclined portion 16c is inclined downward from the slide plate 14, and the contact portion 16d is held at a fixed height in the lower part of the slide plate 14.

The contact portion 16d of the lift member 16 is located just under the suspension 11, where it does not contact the suspension 11 if the slide plate 14 moves to the furthest depth in which case the magnetic head 10 contacts the disk 2 (refer to FIG. 7). In FIG. 4, the slide plate 14 is positioned most forward. In this case, the inclined portion 16c is upon overhangs 9b formed on both sides of an opening 9a on the top surface of the holder 9, the lift member 16 rotates upward, the contact portion 16d rises and pushes the suspension 11 upward, and the magnetic head 10 is at a position having receded into the upper part of the disk cartridge 1.

Furthermore, the holder 9 has a holder link 24 as an example of a link member of the present invention provided on a side surface thereof. An end 241 of the holder link 24 is coupled to the chassis 5, and a part of the side surface of the holder link 24 is engaged with an engagement projection 9c on the side surface of the holder 9. Moreover, a projection 25 is formed at the end of the holder link 24. When the holder 9 is at a position parallel with the chassis 5, the projection 25 is below the arm portion 16e of the lift member 16 projecting on the side surface of the holder 9 and is in a non-contact state. If the holder 9 rotates and rises, the end portion of the holder link 24 gets up, and the projection 25 contacts the arm portion 16e of the lift member 16 so as to upheave the lift member 16. Thus, the suspension 11 gets to the highest position at the position to which the holder 9 has risen (refer to FIG. 10).

FIG. 6 is a plan view of the disk drive according to the present invention in a state in which the magnetic head has descended, and FIG. 7 is a cross-sectional view thereof. If the disk cartridge 1 is mounted and the slide plate 14 is moved to the deepest portion by the elevating motor 18, the lift member 16 recedes to a position not contacting the suspension 11 and the magnetic head 10 descends to the surface of the disk 2.

In this case, the contact portion 16d of the lift member 16 goes into the opening 1a of the disk cartridge 1, and is positioned between the disk 2 and the suspension 11. Here, because of the notch 1e and chamfer 1f, the contact portion 16d can secure the length of a range for, without contacting an edge of the opening 1a of the disk cartridge 1, moving the suspension 11 of the magnetic head 10 from the inner radius to the circumference. Compared to the past cases where a central portion 462 of a lift plate 46 corresponding to the contact portion 16d could only descend to a window portion 391 of a holder 39, the contact portion 16d descends to the inside of the opening 1a of the disk cartridge 1. Thus, a sufficient space can be taken between the contact portion 16d and suspension 11, and so it is possible to render the apparatus lower-profile by reducing lift amounts.

To be more specific, the magnetic head base 12 is provided at a height capable of securing a minimum clearance for preventing the disk cartridge 1 and lift member 16 from contacting the suspension 11, and is positioned lower than the past example. This holds down the thickness of the apparatus.

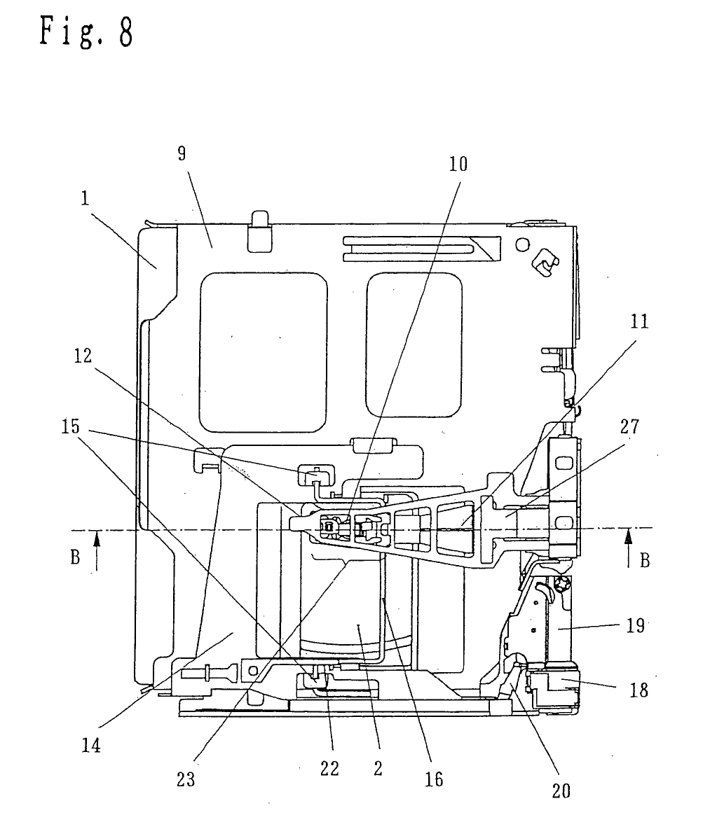

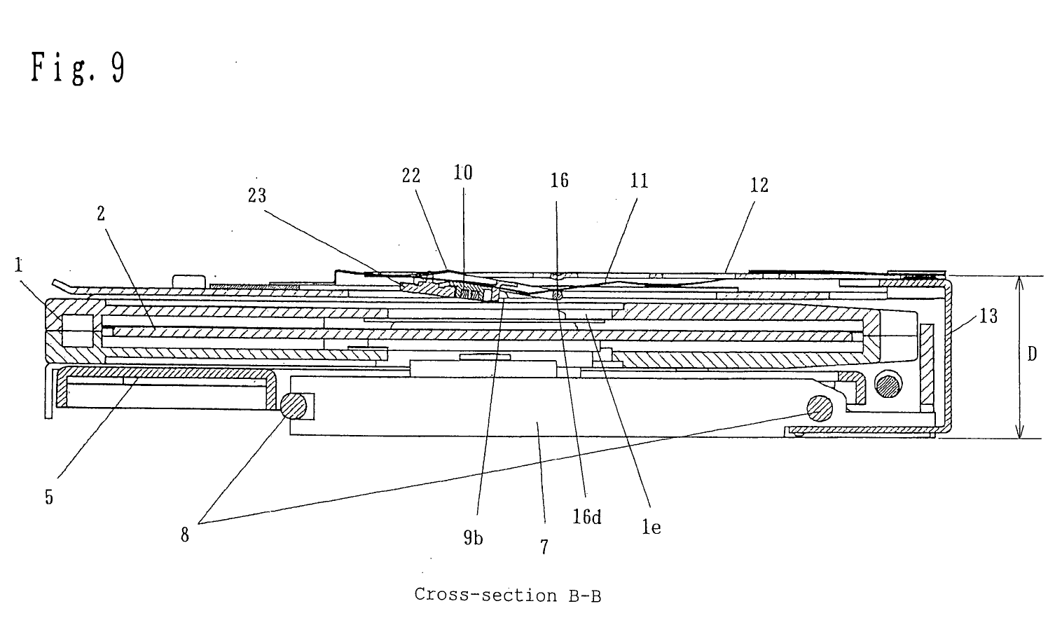

FIG. 8 is a plan view of the disk drive according to the present invention in the state of having the magnetic head lifted up, and FIG. 9 is a cross-sectional view thereof. If the elevating motor 18 is rotated and the slide plate 14 is moved most forward by movement of the driving arm 20, the lift member 16 moves forward together. At the same time, the inclined portion 16c gets upon the overhangs 9b of the holder 9, and the contact portion 16d rises and contacts the suspension 11 to upheave the magnetic head 10. The magnetic head 10 is supported by the lift plate 16 near a gimbal suspension portion 23, and the end portion contacts the magnetic head base 12.

The suspension 11 is inflected by the thickness between the lift plate 16 and magnetic head base 12 so as to be in the state of having receded in the upper part of the cartridge. As the magnetic head base 12 is provided at a low position, the thickness dimension necessary for the upper part of the cartridge is reduced. In this case, a part of the magnetic head 10 may go into the opening 1a of the disk cartridge 1.

As the end of the magnetic head 10 is pressed by the magnetic head base 12 and is supported by the lift plate 16 at a position close to the end of the suspension 11, it is strong enough against an impact from the outside to avoid a collision with the disk and deformation of the suspension when lifted up.

FIG. 10 is a cross-sectional view of the disk drive according to the present invention in the state of having the holder rotated and upheaved. When replacing the disk cartridge 1, the holder 9 is rotated and raised around the axis provided at the depths of the chassis 5. As shown in FIGS. 8 and 9, the slide plate 14 is at the position where the magnetic head 10 is lifted up. If the holder 9 rotates, the holder link 24 provided on the side surface of the holder 9 gets up, and the projection 25 further upheaves the arm portion 16e of the lift member 16. Thus, even if a part of the magnetic head 10 is at a position to go into the opening 1a of the disk cartridge 1 when lifted up, the magnetic head 10 is further upheaved when replacing the cartridge and completely recedes into the upper part of the disk cartridge 1 as shown in FIG. 10 so as to prevent the contact of the disk cartridge 1 and magnetic head 10.

Next, an invention implemented by the inventor hereof of the disk drive related to the above-mentioned present invention will be described.

To be more specific, a first invention is a disk drive having:

a chassis;

a holder rotatably mounted on the above described chassis for storing a disk cartridge accommodating a disk for recording an information signal;

a spindle motor for rotating and driving the above described disk;

a magnetic head for recording and/or reproducing the information signal on the above described disk;

a suspension for supporting the above described magnetic head;

an angle for moving the above described suspension in a radial direction of the above described disk;

a slide plate mounted on a top surface of the above described holder to be movable in parallel with the above described disk;

a lift member placed under the above described suspension for moving vertically in conjunction with the above described moving operation of the above described slide plate; and

a driving means for moving the above described slide plate, wherein:

a first opening for having the magnetic head for recording and/or reproduction on the above described disk inserted is provided on a first principal surface of the above described cartridge case;

a window portion is provided at a position corresponding to the above described first opening of the above described holder;

in the case where the above described lift member moves to a first position in the upper part, a part of the above described lift member contacts the lower part of the above described suspension so as to upheave the above described magnetic head upward;

in the case where the above described lift member moves to a second position in the lower part, a part of the above described lift member is isolated from the lower part of the above described suspension so that the above described magnetic head contacts the above described disk; and

the second position to which the above described lift member moves is the position at which a part of the above described lift member has gone into the first opening provided on one principal surface of the above described disk cartridge.

In addition, a second invention is the disk drive according to the first invention wherein:

the above described lift member is a member formed by inflecting a wire-like member, and has a contact portion contacting the above described suspension, an inclined portion formed on both sides thereof, an even portion formed following them and an axial portion further provided on both sides thereof, and is rotatably mounted on the above described slide plate by the axial portion; and

in a state in which the above described lift member exists at the above described second position due to a slide of the above described slide plate, the above described contact portion and the above described inclined portion have gone into the window portion of the above described holder and the above described first opening, and the above described even portion is in contact with a part of the above described slide plate; and

in a state in which the above described lift member exists at the above described first position due to the slide of the above described slide plate, the above described inclined portion is caused to contact an overhang formed on a rim of the window portion of the above described holder so that the lift member is upheaved and rotated and the above described contact portion rises so as to upheave the above described suspension.

A third invention is the disk drive according to the first invention wherein:

the above described disk cartridge is the disk cartridge related to any one of the above-mentioned inventions; and

when the above described lift member is at the above described second position, a part of the above described lift member is placed to go into the above described opening of the above described cartridge case and get into a concave portion on an inner radius side of the above described disk so as not to contact the above described cartridge case.

A fourth invention is the disk drive according to the second invention wherein:

the above described lift member further has an arm portion at least on one of the outsides of the above described axial portion;

a link member is rotatably mounted between a part of the above described chassis and a part of the above described holder;

in a state in which the above described holder has descended on the above described chassis side, a part of the above described link member does not contact the arm portion of the above described lift member; and

in a state in which the above described holder has rotated and risen when replacing the above described cartridge, a part of the above described link member contacts the above described arm portion so as to further upheave the above described suspension.

### INDUSTRIAL APPLICABILITY

According to the present invention, it is possible to drop the lift member into the opening without narrowing the width of the magnetic head suspension.

In the case where the notch provided on the inner radius side of the first opening is placed in a range not overlapping the concave portion on the inner surface of the cartridge case formed at a position corresponding to the clamp plate at the center of the disk, it is possible to widen a part of the opening without increasing the thickness of the cartridge.

And in the case where there are the, slide plate slidably mounted on the top surface of the holder, the lift plate rotatably supported on the slide plate and the driving means for moving the slide plate in parallel just by a predetermined amount and the magnetic head is lifted up by moving the lift member going into the opening of the disk cartridge, it is possible to render the drive low-profile without requiring large thickness in the upper part of the cartridge.

In addition, it is possible to constitute the lift member simply and inexpensively and move a position of the lift member securely with the simple configuration.

In addition, it is possible to drop the lift member into the opening without narrowing the width of the magnetic head suspension.

In addition, in the case where the lift member is upheaved by the link member moving in conjunction with the holder so as to be further upheaved simultaneously with the rotary operation of the holder, even if the magnetic head does not recede completely to the upper part of the cartridge when lifted up, it does not contact the cartridge when replacing the cartridge, and so the cartridge can be smoothly replaced. Therefore, the space required for the upper part of the cartridge can be held down to a minimum, and the apparatus can be rendered low-profile.

1. A disk cartridge having a cartridge case for rotatably accommodating a disk for recording an information signal and a shutter, wherein:
a first opening for having a magnetic head for recording and/or reproduction on said disk inserted is provided on a first principal surface of said cartridge case;
a second opening for having a spindle for rotating and driving said disk inserted is provided on a second principal surface of said cartridge case;
said shutter closes or opens said first and second openings;
in an area around said first and second openings corresponding to a sliding range of said shutter, an engraved portion is formed so that said shutter will not project from the thickness of said cartridge case; and
on a part of said engraved portion on one side on an inner radius side of the disk of said first opening, an inner radius side concave portion is formed in the direction in which said first opening widens.

2. The disk cartridge according to claim 1, wherein said inner radius side concave portion is formed by notching a part of said engraved portion.

3. The disk cartridge according to claim 1 or 2, wherein a circumferential side concave portion is formed, in the direction in which said first opening widens, at least in said engraved portion at a position corresponding to said inner radius side concave portion on one side on the circumferential side of the disk of said first opening.

4. The disk cartridge according to claim 3, wherein said circumferential side concave portion is formed by chamfering said engraved portion.

5. The disk cartridge according to claim 1, wherein a clamp plate to be absorbed by said spindle is provided at the center of said disk, a concave portion is formed at a position corresponding to said clamp plate on an inner surface of said cartridge case, and the inner radius side concave portion of said first opening is provided in a range not overlapping said concave portion.
